(19) United States
(12) Patent Application Publication
(10) Pub. No.: US 2009/0240667 A1
(43) Pub. Date: Sep. 24, 2009

(54) SYSTEM AND METHOD FOR ACQUISITION AND DISTRIBUTION OF CONTEXT-DRIVEN DEFINTIONS

(76) Inventor: Edward Baker, London (GB)

Correspondence Address: The Marbury Law Group, PLLC, 11800 SUNRISE VALLEY DRIVE, SUITE 1000, RESTON, VA, 20191, US

(21) Appl. No.: 12/390,689

(22) Filed: Feb. 23, 2009

Related U.S. Application Data
(60) Provisional application No. 61/030,766, filed on Feb. 22, 2008.

(51) Int. Cl. G06F 17/30

(52) U.S. Cl. 707/3; 707/104.1; 707/E17.009; 707/E17.044; 707/E17.108; 715/764

(57) ABSTRACT

A definition exchange system comprises a distribution center that acquires context-driven definitions from any number of content providers and provides access to the context-driven definitions to any number of users. A datastore comprises media files that may be in multiple languages. Audio and visual files are created so that users interested in a specific vocabulary can hear words defined and in context. In a similar manner video files are created in which definitions of words are portrayed visually and aurally to enhance the learning experience.

### CROSS REFERENCE TO RELATED APPLICATIONS

This application claims the benefit of Provisional Application No. 61/030,766 filed Feb. 22, 2008. The 61/030,766 application is incorporated by reference herein, in its entirety, for all purposes.

### BACKGROUND

New vocabulary can be hard to remember. Currently, online word searches and word definitions are textual. For example, a search for the word “discombobulate” in a search engine may return results from online dictionaries and encyclopedias. However, the results will be in the form of textual definitions that lack context and/or nuance.

Additionally, words that sound alike may have different spellings and different meanings (homonyms). Textual definitions of homonyms often fail to provide a useful context to allow a student or other user to learn when to use a particular homonym.

What would be useful is a system and method for acquiring and distributing context-driven definitions that convey not only a literal meaning of a word or term but an audio-visual representation or presentation of the word that imparts context and nuance.

### SUMMARY

A definition exchange system receives context-driven definitions from any number of content providers and provides access to the context-driven definitions to any number of users.

In an embodiment, the user inputs a word into the definition exchange system that the user would like to learn more about.

In another embodiment, the user is sent study words electronically. By way of example and not as a limitation, one or more study words may be sent via e-mail, IM, or SMS. In an embodiment, the study words are selected and sent in a particular order as part of a study plan. In yet another embodiment, the user is presented with one or more tests to evaluate the user's comprehension and retention of the study words.

### DESCRIPTION OF THE FIGURES

FIG. 1 is a block diagram illustrating the logical components of a definition exchange system according to an embodiment.

FIG. 2 is a block diagram illustrating the logical components of a user computing device.

FIG. 3 is a block diagram illustrating the logical components of a definition distribution center according to an embodiment.

FIG. 4 is a block diagram illustrating the logical components of a contributor computing device.

FIG. 5 is a block diagram illustrating a flow of user experience of a definition exchange system according to an embodiment.

FIG. 6 is a block diagram illustrating functional components of a personal computer.

FIG. 7 is a block diagram illustrating functional components of a wireless device.

FIG. 8 is a block diagram illustrating functional components of a server.

### DETAILED DESCRIPTION

In an embodiment, a definition exchange system comprises a distribution center that acquires context-driven definitions from any number of content providers and provides access to the context-driven definitions to any number of users.

In an embodiment, the user inputs a word into the definition exchange system that the user would like to learn more about.

In another embodiment, the user is sent study words electronically. By way of example and not as a limitation, one or more study words may be sent via e-mail, IM, or SMS. In an embodiment, the study words are selected and sent in a particular order as part of a study plan. In yet another embodiment, the user is presented with one or more tests to evaluate the user's comprehension and retention of the study words.

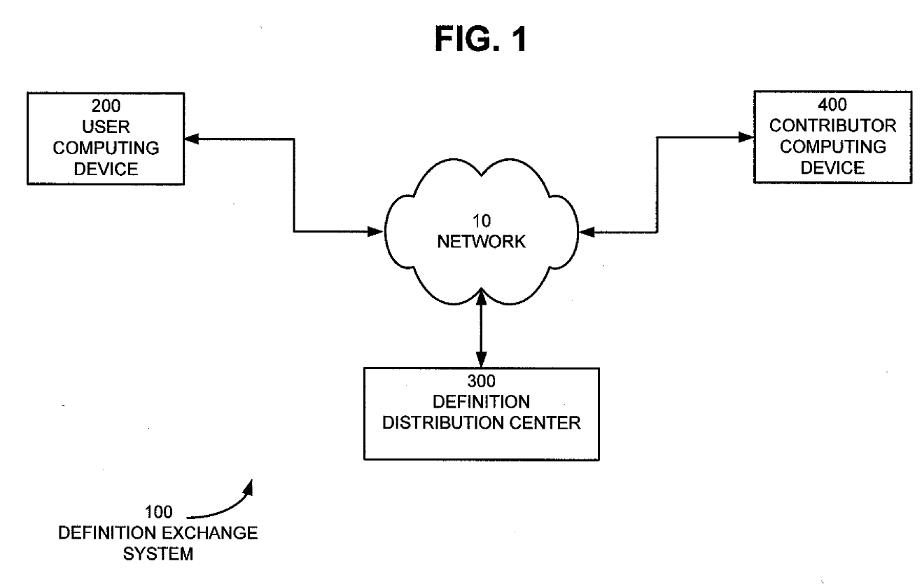

FIG. 1 is a block diagram illustrating the logical components of a definition exchange system according to an embodiment.

A definition exchange system 100 comprises a user computing device 200, a contributor computing device 400, and a definition distribution center 300 interconnected via a network 10.

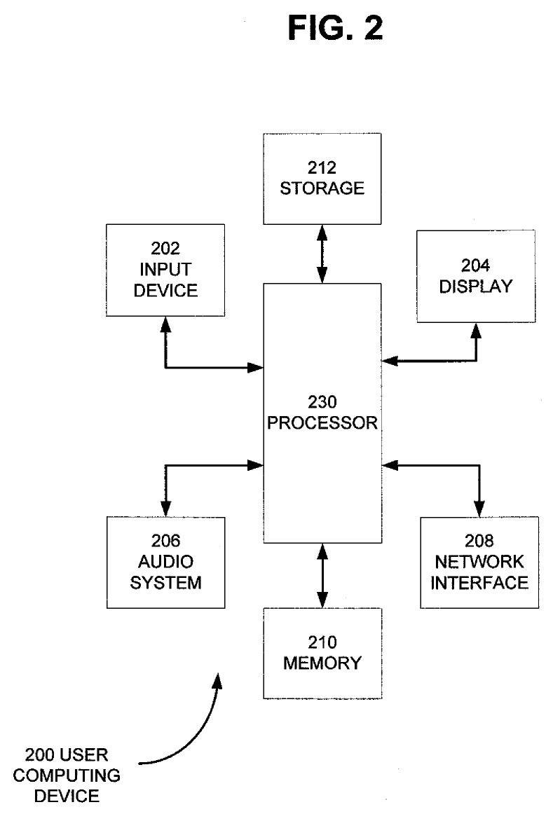

FIG. 2 is a block diagram illustrating selected systems of the user computing device 200. The user computing device comprises an input device 202, a display 204, an audio system 206, a network interface 208, a memory 210, and a storage system 212 under control of a processor 230. By way of illustration and not as a limitation, the computing device 200 may be a desk top computer, laptop computer, a PDA, or a cell phone.

The user computing device 200 communicates over a network 10 via the network interface 208 to the definition distribution center 300. In an embodiment, the network 10 is the Internet but this is not meant as a limitation. The network 10 may be wired or wireless, a private network, a local area network or a wide area network, or a combination of these elements.

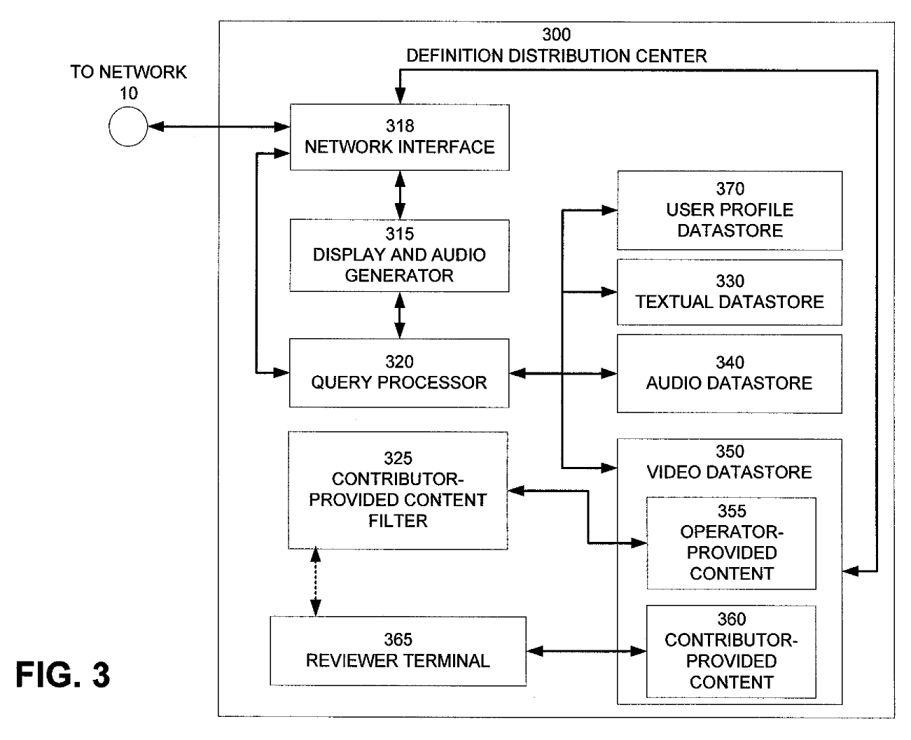

FIG. 3 is a block diagram illustrating the logical components of a definition distribution center according to an embodiment. The definition distribution center 300 comprises a display and audio generator 315, a network interface 318, a query processor 320, a user-provided content filter 325, a textual datastore 330, an audio datastore 340, a video datastore 350, and a user profile datastore 370.

In an embodiment, a user presents a word query to the network interface 318 via the network 10. The query is generated by the user computing device 200 in response to user input from the input device 202 (see, FIG. 2). The user may select a word at random or in response to receipt of one or more study words. The query processor 320 accesses the textual datastore 330 to obtain a written definition of the word presented in the query.

This definition is received by the query processor 320 and provided to the display and audio generator 315. The display and audio generator 315 receives the textual data and converts into a form that can be displayed by user computing device 200 (see, FIG. 2). The display is returned to the user computing device 200 via the network 10 and displayed on the display 204 (see, FIG. 2).

The query processor 320 also accesses the audio datastore 340 to obtain aurally presented information about the word and provides the information to the display and audio generator 315. The display and audio generator 315 receives the audio data and converts it into a form that can be processed by the audio system 206 of user computing device 200 (see, FIG. 2). The converted audio data is returned to the user computing device 200 via the network 10 (see, FIG. 2). By way of illustration and not as a limitation, the aurally presented information may be a pronunciation of the word spoken by a native speaker, a primary definition, and one or more alternative definitions. The spoken information may further comprise the grammatical attributes of the word and the etymology of the word. In an embodiment, the extent of the verbal information provided in response to the query may be user determined and conveyed in the query.

In another embodiment, the textual information and the aurally presented information may be coordinated by the query processor 320 so that the display of the textual information and the presentation of the verbal information are choreographed to enhance the presentation to the user. Thus, the textual display and the aurally presented information may be synchronized so that the pronunciation corresponds to the display of the word.

The query processor 320 also accesses the video datastore 350 and provides the information to the display and audio generator 315. The display and audio generator 315 receives the video data and converts it into a form that can be processed by the display system 204 of user computing device 200 (see, FIG. 2). The converted video data is returned to the user computing device 200 via the network 10 (see, FIG. 2).

The video datastore 350 comprises storage for an operator-provided content 355 and a contributor-provided content 360. In an embodiment, the operator-provided content storage 355 comprises video presentations of words that are prepared by or for the operator of the definition exchange system 100. By way of illustration and not as a limitation, an operator may use trained actors, entertainers, educators, linguists, animators and/or announcers to present a video comprising a definition of the word and a sentence in which the word is used. The objective of the operator-provided content is to provide a user a memory aid or mnemonic so that the word is more easily remembered.

The contributor-provided content storage 360 comprises video presentations of words prepared by contributors and uploaded to the definition distribution center 300. Those contributors may be members of a definition exchange system community and may be polled via emails, for example, to provide their own visual presentation of words that the system operator will want to have available on-line to all users. Various incentives can be provided to encourage this type of community input. In an embodiment, the contributor-provided content 360 is processed before storage by the user-provided content filter 325.

In this embodiment, the audio and video uploaded to the definition distribution system 300 is evaluated for particular words or images prior to transfer to user-provided content storage 360. Optionally, the results of the review by the content filter 325 may be sent to a reviewer terminal for evaluation by one or more reviewers. The reviewers may overrule the content filter 325 and allow content to pass to the user-provided content storage 360 or deny the storage of the user provided content. In an alternate embodiment, the user provided content filter 325 is not used and all user-provided content is directed to the reviewer terminal 365 for evaluation. In an additional embodiment, other users may provide the review and allow content to pass to storage either in combination with user-provided content filter and reviewers or on their own.

In an embodiment, video content that is stored in the video datastore 350 is alphabetically catalogued such that the audio-visual presentation may be appended to the textual definition to which it pertains. The users of the site will be able to search for a word definition and access both operator and contributor-provided audio-visual presentation interpretations. If a word has not been visually defined then users may be encouraged to join the community and interact by uploading their own definition.

In an embodiment, the logical components of a definition exchange system 100 are configured for use as a tool in an educational setting. The user computing device 200 (described in detail above in reference to FIG. 2) is associated with a user identifier. The user identifier may be conveyed in the word query generated by the user computing device 200. The user identifier may be used to access the user profile datastore 370.

The user profile datastore 370 comprises identifying information of a user and user preferences and entitlements. By way of illustration and not as a limitation, user identifying information may include the user's age, education level, native language, foreign language comprehension level, school affiliation, course enrollment, e-mail information, and other information. The user preferences may include screen color, word size, video format, verbal information level, and similar information. The user entitlements may include descriptors that determine words that the user is permitted to access, whether the user is permitted to access operator provided content and user-provider content, and whether the user is entitled to upload user-provided content.

In an embodiment, a user registers with the definition distribution center 300. The user may create his or her “Member Page.” The Member Page allows the registered user to manage audio-visual presentations, track favorite content presenters, and interact with the community.

In this embodiment, the query processor 320 accesses the user profile datastore 370 prior to accessing other datastores to determine any limitations on the user's word queries. If the query processor 320 determines that the user is entitled to submit a query for a proffered word, the query processor 320 then accesses the textual datastore 330, the audio datastore 340, and the video datastore 350 as previously described.

In an embodiment, the information and content stored in the textual datastore 330, the audio datastore 340, and the video datastore 350 are rated to indicate the appropriateness of the information and content for a given audience. Thus, textual, audio and video content can be identified as appropriate for students in specific grades, specific age groups and by other demographic filters. Similarly, textual, audio and video content may be identified as appropriate for users having a specific knowledge of the language in which the word is to be defined. The query processor 320 selects the content from the various datastores that is appropriate to the use based on the user's profile and sends that to the user in response to the query.

It will also be appreciated by those skilled in the art that various sites having definitions of desired words in one language can be linked to definition distribution centers in other languages thereby allowing audio, visual and text definitions in multiple languages to be displayed for a user to enhance the learning experience.

In an embodiment, a user's profile limits the user's access to operator-provided content 355. In another embodiment, the contributor-provided content 360 is rated and is provided to the user based on the user's profile.

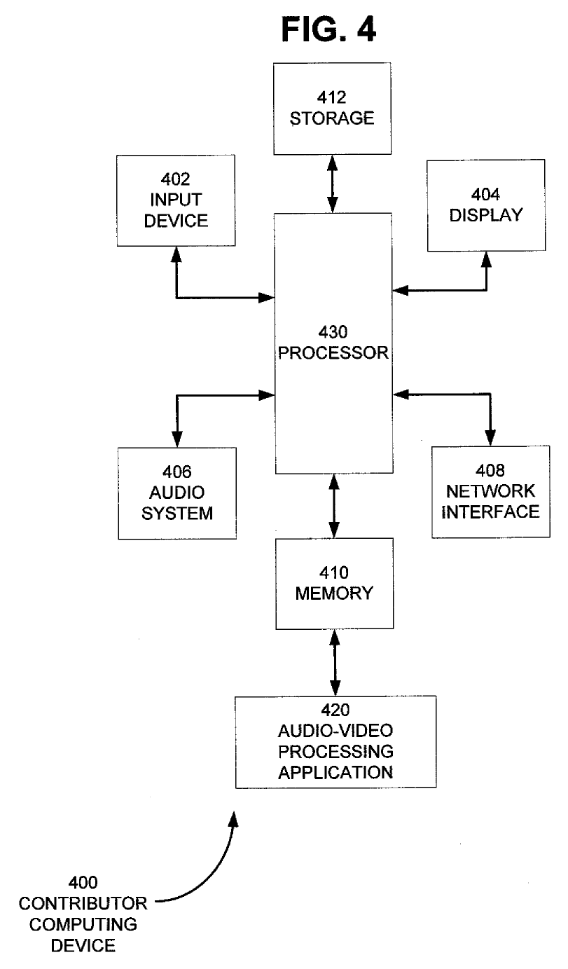

FIG. 4 is a block diagram illustrating selected systems of the contributor computing device 400. The contributor computing device comprises an input device 402, a display 404, an audio system 406, a network interface 408, a memory 410, and a storage system 412 under control of a processor 430. The contributor computing device 400 further comprises audio-video processing application 420. The audio-video processing application 420 is stored in memory 410 and executed by the processor 430 to provide the contributor computing device the capability of producing audio, video and multimedia files.

By way of illustration and not as a limitation, the contributor computing device 400 may be a desk top computer, laptop computer, a PDA, or a cell phone.

The contributor computing device 400 communicates over a network 10 via the network interface 408 to the network interface 318 of the definition distribution center 300. In an embodiment, the network 10 is the Internet but this is not meant as a limitation. The network 10 may be wired or wireless, a private network, a local area network or a wide area network, or a combination of these elements. The network interface 318 interacts with video datastore 350 to permit contributor-provided content to be stored in the video datastore 350 as described above.

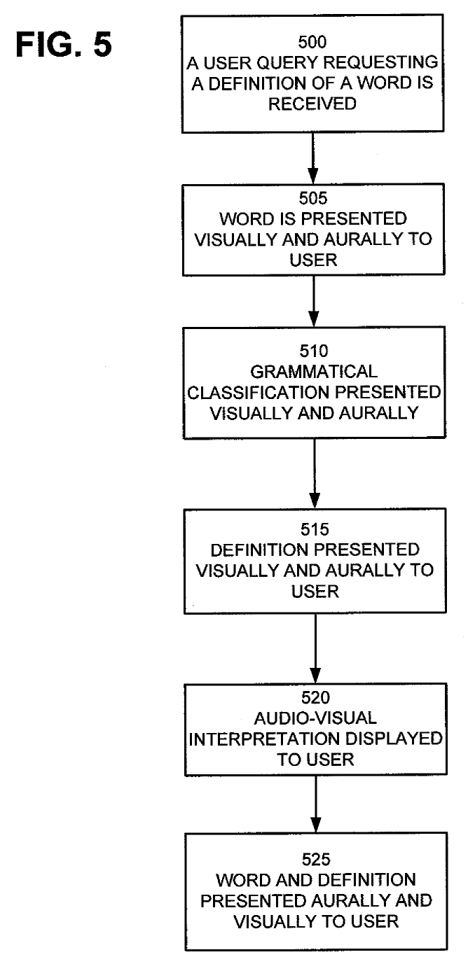

FIG. 5 illustrates a flow of a user experience according to an embodiment. A query for a word is sent from a user and received at the definition exchange system 500. The word is presented to the user visually as text and aurally 505 in the form of a narrator's pronunciation of the word that is played through a user computing device (FIG. 2, 200). For example, if the query is for the word “discombobulate,” a pronunciation of the word discombobulate will be heard by the user while the word is displayed on the user computing device.

The grammatical classification of the word is presented to the user visually as text and aurally 510 in the form of a narrator's reading of the classification that is played through the user computing device (FIG. 2, 200). For example, if the query is for the word “discombobulate,” the words “transitive verb” will be heard by the user while the words are displayed on the computing device 200 (see, FIG. 2).

The definition of the word is presented to the user visually as text and aurally 515 in the form of a narrator's reading of the definition that is played through the user computing device (FIG. 2, 200). For example, if the query is for the word “discombobulate,” the words “to throw into a state of confusion” will be heard by the user while the same words are displayed on the computing device.

An audio-visual interpretation of the word may also be presented to the user 520. The audio-visual presentation defines what the word means in a context that may be entertaining, topical, revealing, insightful, comic, or profound. For example, if the query is for the word “discombobulate,” the audio-visual interpretation might be, “Ask a weather forecaster to explain the weather and he may become discombobulated.”

After the audio visual presentation, the word and definition may be presented aurally to the user 525 again. It should be noted that a visual confirmation may take place if it is deemed necessary for the learning experience.

In another embodiment, individuals may collectively participate to create a language and to contribute to a collective pool of produced and user-generated audio-visual presentation definition exchange system definitions.

In another embodiment, user computing device 200 (see, FIG. 2) is configured to operate a client application. Using this client application, a user may check the meaning of a word written on any webpage. By way of an example and not as a limitation, a user using the client application may designate a word on a webpage via a “mouse click.” The “click” causes a pop-up window to appear displaying the meaning of the word as stored in the textual datastore 330 of definition distribution center 300. In addition to the text data, the pop-up window may provide an indication if a video definition is available giving the user the option to view that video presentation of the requested word.

While the capability of the definition exchange system 100 has been disclosed with respect to user computing device 200 (see, FIG. 2), those skilled in the art will also appreciate that the system can be embodied in a manner that is useful to mobile devices. For example, cell phones, PDA's and other mobile devices may all perform the functions of user computing device 200.

The input mechanism for designating a word to be defined should also not be interpreted as limited to keystroke input. It is well within the capabilities of the art to apply speech processing as an input means. Thus a user can speak a term, have that term recognized, and subsequently have a text, audio and/or audio-visual presentation of the word definition given to the user in any desired language.

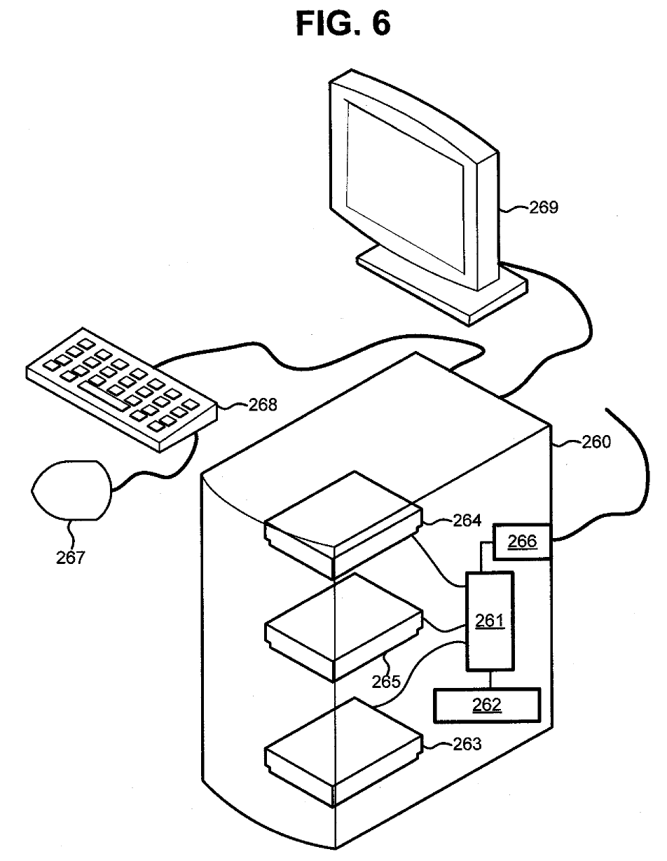

As previously described, a user may interact with a messaging system using a variety of the computing devices, including a personal computer. By way of illustration, the functionality of the computing device 200 may be implemented on a personal computer 260 illustrated in FIG. 6. Such a personal computer 260 typically includes a processor 261 coupled to volatile memory 262 and a large capacity nonvolatile memory, such as a disk drive 263. The computer 260 may also include a floppy disc drive 264 and a compact disc (CD) drive 265 coupled to the processor 261. Typically the computer device 260 will also include a pointing device such as a mouse 267, a user input device such as a keyboard 268 and a display 269. The computer device 260 may also include a number of connector ports coupled to the processor 261 for establishing data connections or receiving external memory devices, such as a USB or FireWire® connector sockets or other network connection circuits 266 for coupling the processor 261 to a network. In a notebook configuration, the computer housing includes the pointing device 267, keyboard 268 and the display 269 as is well known in the computer arts.

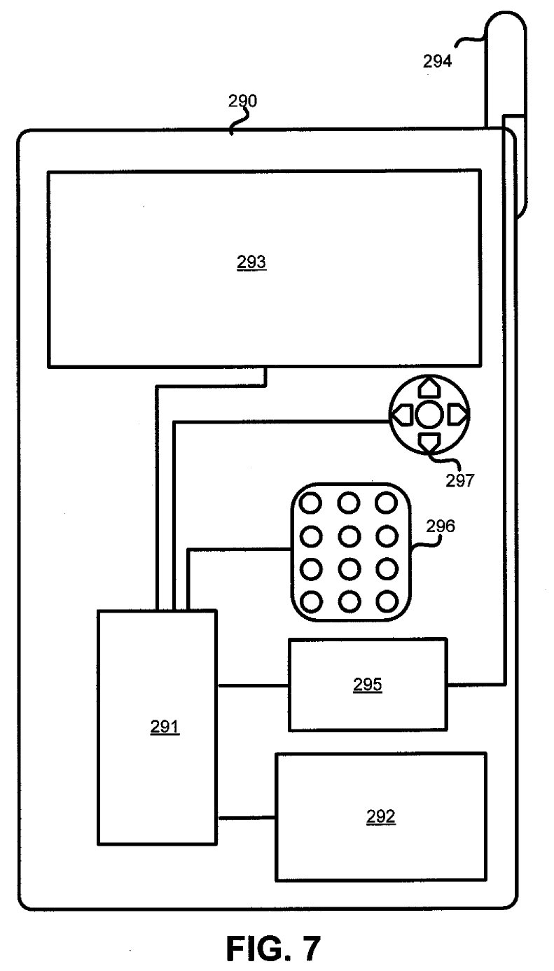

As previously described, a user may interact with a messaging system using a variety of the computing devices, including mobile devices. Typical mobile devices suitable for use with the various embodiments will have in common the components illustrated in FIG. 7. For example, the exemplary mobile device 290 may include a processor 291 coupled to internal memory 292, a display 293 and to a SIM 299 or similar removable memory unit. Additionally, the mobile device 290 may have an antenna 294 for sending and receiving electromagnetic radiation that is connected to a wireless data link and/or cellular telephone transceiver 295 coupled to the processor 291. In some implementations, the transceiver 295 and portions of the processor 291 and memory 292 used for cellular telephone communications are collectively referred to as the air interface since it provides a data interface via a wireless data link. Mobile devices typically also include a key pad 296 or miniature keyboard and menu selection buttons or rocker switches 297 for receiving user inputs.

The processor 291 may be any programmable microprocessor, microcomputer or multiple processor chip or chips that can be configured by software instructions (applications) to perform a variety of functions, including the functions of the various embodiments described herein. In some mobile devices, multiple processors 291 may be provided, such as one processor dedicated to wireless communication functions and one processor dedicated to running other applications. Typically, software applications may be stored in the internal memory 292 before they are accessed and loaded into the processor 291. In some mobile devices, the processor 291 may include internal memory sufficient to store the application software instructions. The internal memory of the processor may include a secure memory 298 which is not directly accessible by users or applications and that is capable of recording MDINs and SIM IDs as described in the various embodiments. As part of the processor, such a secure memory 298 may not be replaced or accessed without damaging or replacing the processor. In some mobile devices, additional memory chips (e.g., a Secure Data (SD) card) may be plugged into the device 290 and coupled to the processor 291. In many mobile devices, the internal memory 292 may be a volatile or nonvolatile memory, such as flash memory, or a mixture of both. For the purposes of this description, a general reference to memory refers to all memory accessible by the processor 291, including internal memory 292, removable memory plugged into the mobile device, and memory within the processor 291 itself, including the secure memory 298.

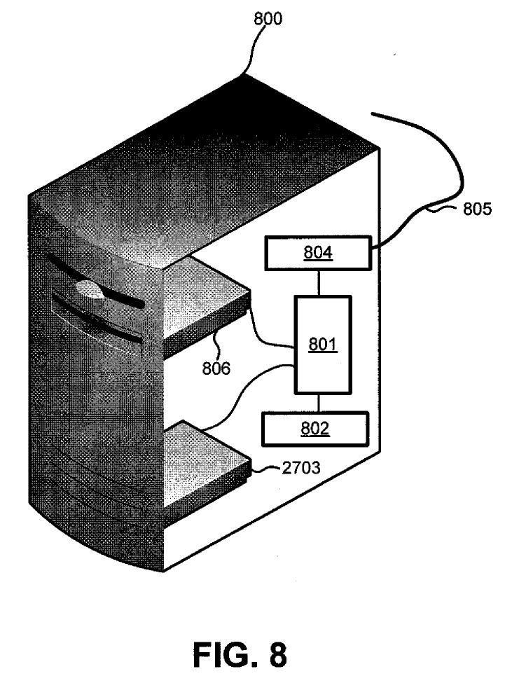

A number of the aspects described above may also be implemented with any of a variety of remote server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disk drive and/or a compact disc (CD) drive 806 coupled to the processor 801. The server 800 may also include a number of connector ports 804 coupled to the processor 801 for establishing data connections with network circuits 805.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein.

What is claimed is:

1. A system for displaying a definition comprising:
a datastore having stored therein a text file stored in a datastore, wherein the text file comprises a textual definition of a selected word;
a processor, wherein the processor is configured with software executable instructions to perform operations comprising:
receiving an audio-video file from a contributor computer, wherein the audio-video file comprises an audio-visual representation of a definition of a selected word;
associating the audio-video file with the text file and storing the audio-video file in the datastore;
receiving a request for the definition of the word from a user computer;
accessing the audio-video file and text file in the datastore;
generating a display of the definition of the word, wherein the definition comprises the audio-video file and the text file and wherein the display presents the text file and the audio-video file in a pre-determined timing relationship; and
sending the display to the user computer; and
a user computer, wherein the user computer is configured with software executable instructions to perform operations comprising displaying the display on the user computer.

2. The system of claim 1, wherein the textual definition is in a selected language.

3. The system of claim 1, wherein the audio-video file is in a selected language.

4. The system of claim 1, where the instruction for associating the audio-video file with the text file and storing the audio-video file in the datastore comprises:
determining a language of the text file;
determining a language of the audio-video file;
when the text file and the audio-video file are in the same language, then associating the audio-video file with the text file and storing the audio-video file in the datastore.

5. The system of claim 1, wherein the user computing device is selected from the group consisting of a desktop computer, a laptop computer, a PDA and a cellphone.

6. The system of claim 1, wherein the contributor computing device is selected from the group consisting of a desktop computer, a laptop computer, a PDA and a cellphone.

7. The system of claim 1, wherein the user computing device comprises a pointing device and wherein the user computer is configured with software executable instructions to perform operations further comprising:
selecting a word using the pointing device;
generating a request for the definition of the word; and
sending the request to the processor.

8. The system of claim 7, wherein the pointing device is selected from the group consisting of a mouse, a keyboard, a keypad, and a touch screen.

9. A method for displaying a definition comprising:
receiving an audio-video file from a contributor computer, wherein the audio-video file comprises an audio-visual representation of a definition of a selected word;
associating the audio-video file with a text file stored in a datastore, wherein the text file comprises a textual definition of the selected word and storing the audio-video file in the datastore;
receiving a request for the definition of the word from a user computer;
accessing the audio-video file and text file in the datastore;
generating a display of the definition of the word, wherein the definition comprises the audio-video file and the text file and wherein the display presents the text file and the audio-video file in a pre-determined timing relationship;
sending the display to the user computer; and
displaying the display on the user computer.

10. The method of claim 9, wherein the textual definition is in a selected language.

11. The method of claim 9, wherein the audio-video file is in a selected language.

12 The method of claim 9, where associating the audio-video file with the text file and storing the audio-video file in the datastore comprises:
determining a language of the text file;
determining a language of the audio-video file;
when the text file and the audio-video file are in the same language, then associating the audio-video file with the text file and storing the audio-video file in the datastore.

13. The method of claim 9, wherein the user computing device is selected from the group consisting of a desktop computer, a laptop computer, a PDA and a cellphone.

14. The method of claim 9, wherein the contributor computing device is selected from the group consisting of a desktop computer, a laptop computer, a PDA and a cellphone.

15. The method of claim 9, wherein the user computing device comprises a pointing device and wherein the method further comprises:
selecting a word using the pointing device;
generating a request for the definition of the word; and
sending the request.

16. The system of claim 15, wherein the pointing device is selected from the group consisting of a mouse, a keyboard, a keypad, and a touch screen.
